(19) United States
(12) Patent Application Publication
(10) Pub. No.: US 2005/0182884 A1
(43) Pub. Date: Aug. 18, 2005

(54) Multiple address two channel bus structure

(76) Inventors: Richard Gerard Hofmann, Cary, NC (US); Jaya Prakash Subramaniam Ganasan, Youngsville, NC (US); Thomas John Lowery, Cary, NC (US); Perry Willmann Remaklus, JR., Raleigh, NC (US)

Correspondence Address: Qualcomm Incorporated;Patents Department, 5775 Morehouse Drive, San Diego, CA, 92121-1714, US

(21) Appl. No.: 10/833,716

(22) Filed: Apr. 27, 2004

Related U.S. Application Data
(60) Provisional application No. 60/538,505, filed on Jan. 22, 2004.

(51) Int. Cl. H04L 5/14; G06F 13/00

(52) U.S. Cl. 710/305; 370/294; 711/154

(57) ABSTRACT

A processing system is disclosed with a sending component and a receiving component connected by a multiple address two channel bus. The sending device may broadcast on the first channel of the bus read address information comprising a plurality of read address locations, write address information comprising a plurality of write address locations, and write data. The sending component may also broadcast the read and write address information multiple address locations at a time. The receiving component may store the write data broadcast on the first channel based on the write address information, retrieve the read data from the receiving component based on the read address information, and broadcasting the retrieved read data on the second channel of the bus.

### RELATED APPLICATION

This application claims priority to U.S. Provisional Application No. 60/538,505, filed Jan. 22, 2004.

### FIELD

The present disclosure relates generally to digital systems, and more specifically, to a multiple address two channel bus structure.

### BACKGROUND

Computers have revolutionized the electronics industry by enabling sophisticated processing tasks to be performed with just a few strokes of a keypad. These sophisticated tasks can involve a number of complex components that communicate with one another in a fast and efficient manner using a bus. A bus is a channel or path between components in a computer.

A typical computer includes a processor with system memory. A high bandwidth system bus may be used to support communications between the processor and system memory. In addition, there may also be a lower performance bus which is used to transfer data to lower bandwidth components. In some cases, there may also be a configuration bus which is used for the purpose of programming various resources. Bridges may be used to efficiently transfer data between the higher and lower bandwidth buses, as well as provide protocol translation.

Commonly buses resident in a computer have been implemented as shared buses. A shared bus provides a means for any number of components to communicate over a common path or channel. Recently by point-to-point switching connections have become more popular. Point-to-point switching connections provide a direct connection between two components on the bus while they are communicating with each other. Multiple direct links may be used to allow several components to communicate without slowing each other down.

Conventional bus design commonly includes independent and separate read, write and one or more address channels. A processor, for example, can read or write to system memory by placing an address location on the address channel and sending the appropriate read/write control signal. When the microprocessor writes data to system memory, it sends the data over the write channel. When the microprocessor reads data from system memory, it receives the data over the read channel.

Although this particular bus structure provides a fairly standardized way to communicate between components of a computer, it requires a number of dedicated channels. These channels require driver, receiver and buffer circuits, all which consume power. In integrated circuit applications, these channels occupy valuable chip area. Accordingly, there is a need in the art for a simplified bus structure.

### SUMMARY

In one aspect of the present invention, a method of communicating between a sending component and a receiving component over a bus includes broadcasting from the sending component on a first channel read address information comprising a plurality of read address locations, write address information comprising a plurality of write address locations, and write data. The sending component also broadcasts the read and write address information multiple address locations at a time. The method further includes storing the write data broadcast on the first channel at the receiving component based on the write address information, retrieving read data from the receiving component based on the read address information, and broadcasting from the receiving component the retrieved read data on the second channel.

In another aspect of the present invention, a processing system includes a bus having first and second channels, a sending component and a receiving component. The sending component is configured to broadcast on the first channel read address information comprising a plurality of read address locations, write address information comprising a plurality of write address locations, and write data. The sending component is further configured to broadcast the read and write address information multiple address locations at a time. The receiving component is configured to store the write data broadcast on the first channel based on the write address information, retrieve read data based on the read address information, and broadcast the retrieved read data on the second channel to the sending component.

In a further aspect of the present invention, a processing system includes a bus having first and second channels. The processing system also includes means for broadcasting on the first channel read address information comprising a plurality of read address locations, write address information comprising a plurality of write address locations, and write data, the read and write address information being broadcast multiple address locations at a time. The processing system further includes means for storing the write data broadcast on the first channel based on the write address information, retrieving the read data based on the read address information, and broadcasting the retrieved read data on the second channel to the sending component.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is a conceptual block diagram illustrating an example of a point-to-point connection over a two channel bus between two components in a processing system;

FIG. 2 is a conceptual block diagram illustrating an example of a point-to-point connection over a multiple address two channel bus between two components in a processing system;

FIG. 3 is a timing diagram showing four address pipelined read operations over a multiple address two channel bus;

FIG. 4 is a timing diagram showing six address pipelined read operations over a multiple address two channel bus; and

FIG. 5 is a timing diagram showing read and write operations over a multiple address two channel bus.

### DETAILED DESCRIPTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

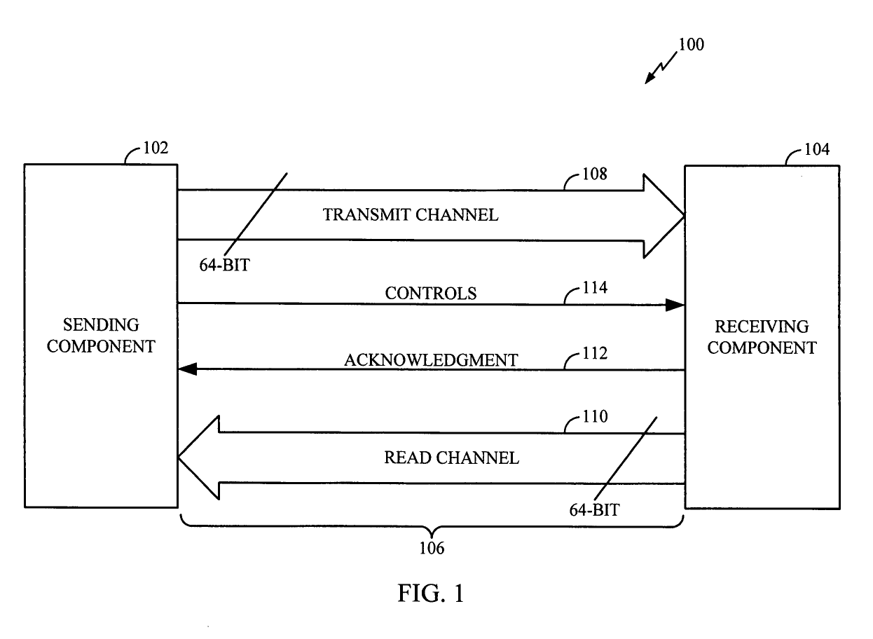

FIG. 1 is a conceptual block diagram illustrating an example of a point-to-point connection over a bus between two components in a processing system. The processing system 100 may be a collection of components that cooperate to perform one or more processing functions. Commonly, the processing system will be a computer, or resident in a computer, and capable of processing, retrieving and storing information. The processing system may be a stand-alone system. Alternatively, the processing system may be embedded in any device, including by way of example, a cellular telephone.

The processing system 100 is shown with a sending component 102 in communication with a receiving component 104 over a bus 106. In one embodiment of the processing system 100, the bus 106 is a dedicated bus between the sending component 102 and the receiving component. In another embodiment of the processing system 100, the sending component 102 communicates with the receiving component 104 with a point-to-point connection over the bus 106 through a bus interconnect (not shown). Moreover, as those skilled in the art will readily appreciate, the inventive aspects described throughout this disclosure are not limited to a dedicated bus or point-to-point switching connection, but may be applied to any type of bus technology including, by way of example, a shared bus.

The sending component 102 may be any type of bus mastering component including, by way of example, a microprocessor, a digital signal processor (DSP), a direct memory access controller, a bridge, a programmable logic component, discrete gate or transistor logic, or any other information processing component.

The receiving component 104 may be any storage component, including, by way of example, registers, memory, a bridge, or any other component capable of retrieving and storing information. The storage capacity at each address location of the receiving component may vary depending on the particular application and the overall design constraints. For the purposes of explanation, the receiving component will be described with a storage capacity of 1-byte per address location.

The complexity of the bus 106 may be reduced in this example by eliminating the address channel that is used in conventional bus structures. The elimination of the address channel may be achieved by redefining the write channel as a “transmit channel” 108. The transmit channel 108 may be used as a generic medium for broadcasting information between the sending component 102 and the receiving component 104 in a time division multiplexed fashion.

The sending component 102 may read from or write to the receiving component 104. In the case where the sending component 102 writes to the receiving component 104, the sending component 102 may sample one or more sideband signals 112 for an acknowledgement that the receiving component 104 is ready to perform a write operation. If the sending component 102 receives an acknowledgement, it may broadcast an address location on the transmit channel 108 followed by write data. The sending component 102 may also use one or more sideband signals 114 to request a write operation and indicate the number data bytes being broadcast. If the write data is multiple bytes, then the receiving component 104 may store the data in a block of sequential address locations beginning with the address location broadcast on the transmit channel 108. By way of example, if the sending device broadcasts an address location 100_{HEX} followed by 4-bytes of write data, the receiving component may write the data to a block of address locations starting at 100_{HEX} and ending at 103_{HEX}. The 4-bytes of write data is referred to as the “payload.”

In the case where the sending component 102 reads from the receiving component 104, the sending component 102 may sample one or more of the sideband signals 112 for an acknowledgement that the receiving component 104 is ready to perform a read operation. If the sending component 102 receives an acknowledgement, it may broadcast an address location on the transmit channel 108. The sending component 102 may use one or more of the sideband signals 114 to request a read operation and indicate the number data bytes being broadcast. If the read data is multiple bytes, then the receiving component may read data from a block of sequential address locations beginning with the address location broadcast on the transmit channel 108. By way of example, if the sending device broadcasts an address location 200_{HEX} and requests 4-bytes of read data, the receiving component may retrieve the read data from a block of address locations starting at 200_{HEX} and ending at 203_{HEX}.

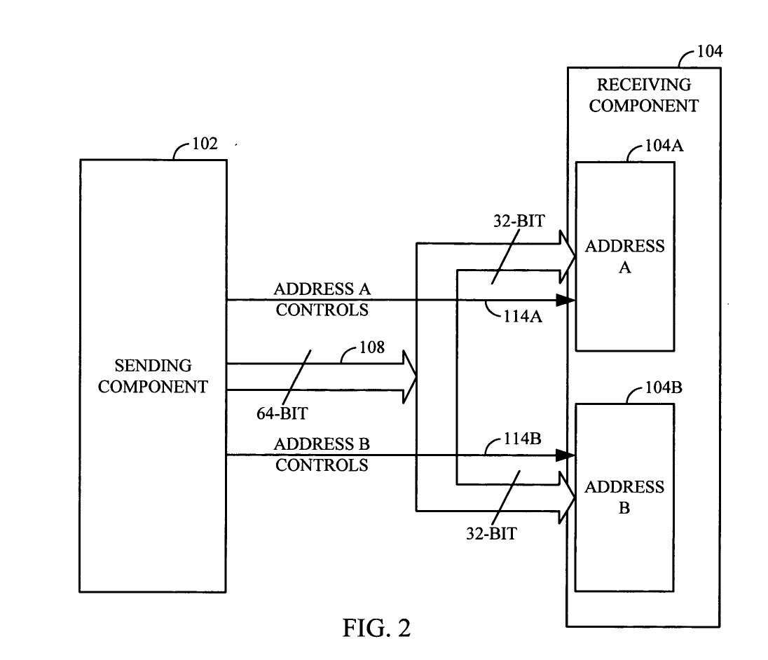

FIG. 2 is a conceptual block diagram illustrating an example of a point-to-point connection over a multiple address two channel bus between two components in a processing system. In the embodiment shown in FIG. 2, the sending component 102 may use the transmit channel 108 to broadcast two different address locations 104a and 104b within the receiving component 104 at the same time. One or more sideband signals 114a and 114b may be associated with each of the address locations. It will be understood that the sending component 102 may also use the transmit channel 108 to broadcast a single address location to two different receiving components at the same time in shared bus applications. If the receiving component is a bridge, one or both address locations may be used to access the bridge, or alternatively access another receiving component on the other side of the bridge. Alternative embodiments of the bus may include a transmit channel configured to support a simultaneous broadcast of any number of address locations to multiple receiving components, multiple address locations within a receiving component, or any combination thereof.

The use of the transmit channel 108 to simultaneously broadcast multiple address locations may improve performance by providing address information to the receiving component sooner, thus decreasing the amount of read latency. In addition, the simultaneous broadcast of multiple address locations may allow a more efficient return of read data to the sending component 102 over the read channel 110.

In multiple address bus applications, the transmit channel 108 may be 64-bits wide to support two 32-bit addresses. The first 32-bit address, which will be referred to as “Address A,” may be used to broadcast one address location 104a. The second 32-bit address, which will be referred to as “Address B,” may be used to broadcast the other address location 104b. With this configuration, the sending component 102 may initiate (1) two read operations simultaneously, (2) two write operations simultaneously, (3) simultaneous read and write operations at different address locations, or (4) simultaneous read and write operation to the same address location or locations.

An implicit addressing scheme may be used to handle simultaneous read and write operation requests to the same address location. By way of example, the sending component 102 may broadcast the address location for the first operation as Address A, and the address location for the second operation as Address B. The read/write sequence performed by the receiving component 104 will be based on this addressing scheme to maintain sequential consistency. Thus, if the same address location is used as Address A and Address B, and the sending device signals a 1 -byte write operation for Address A and a 1-byte read operation for Address B, then the receiving component 104 will wait until the data broadcast on the transmit channel is written to the address location before providing the newly written data at this address location to the read channel for transmission to the sending component 102. Conversely, if the sending device signals a 1-byte read operation for Address A and a 1-byte write operation for Address B, then the receiving component 104 will provide the data at this address location to the read channel 110 before writing the new data from the transmit channel 108 to this address location.

Alternatively, read and write operation requests to the same address location may be broadcast sequentially. By way of example, the sending component 102 may broadcast the address location for the first operation as Address A during a first clock cycle, and the address location for the second operation as Address B during the following clock cycle. In this case, the receiving component may perform the operation requested during the first clock cycle before performing the operation requested during the second clock cycle.

An implicit addressing scheme may also be used to control the sequence of data broadcast on the transmit and read channels 108 and 110. By way of example, if the sending component initiates a read operation from two address locations simultaneously, the receiving component 104 may broadcast the read data associated with Address A followed by the read data associated with Address B. Similarly, if the sending component initiates a write operation to two address locations simultaneously, the sending component may broadcast the write data associated with Address A followed by the write data associated with Address B. Alternatively, sideband signaling may be used to control the broadcast sequence of the read and write data.

The various concepts described thus far may be implemented using any number of protocols. In the detailed description to follow, an example of a bus protocol will be presented. This bus protocol is being presented to illustrate the inventive aspects of a processing system, with the understanding that such inventive aspects may be used with any suitable protocol. The basic signaling used for this protocol is shown below in Table 1. Those skilled in the art will readily be able to vary and/or add signals to this protocol in the actual implementation of the bus structure described herein.

TABLE 1

| Signal | Definition | Driven By |
|---|---|---|
| System Clock | Reference clock signal | Processing System |
| AA Valid A | a valid Address A is being | Sending Component |
| | broadcast on the transmit | |
| | channel | |
| R/W A | read/write indication for | Sending Component |
| | Address A (0 = write, 1 = read) | |
| Size A | size of the payload associated | Sending Component |
| | with Address A | |
| A Valid B | a valid Address B is being | Sending Component |
| | broadcast on the transmit | |
| | channel | |
| R/W B | read/write indication for | Sending Component |
| | Address B (0 = write, 1 = read) | |
| Size B | size of the payload associated | Sending Component |
| | with Address B | |
| Transfer Ack | indicates receiving component | Receiving |
| | is capable of accepting a request | Component |
| | to perform a read or write | |
| | operation | |
| Transmit Channel | 64-bit bus for broadcasting | Sending Component |
| | address information and write | |
| | data to the receiving component | |
| Write Ack | indicates receiving component | Receiving |
| | is capable of accepting write | Component |
| | data | |
| Read Channel | 64-bit bus for broadcasting read | Receiving |
| | data to the sending component | Component |
| Read Ack | acknowledgement to the | Receiving |
| | sending component that the | Component |
| | receiving component is | |
| | broadcasting read data on the | |
| | Read Channel | |

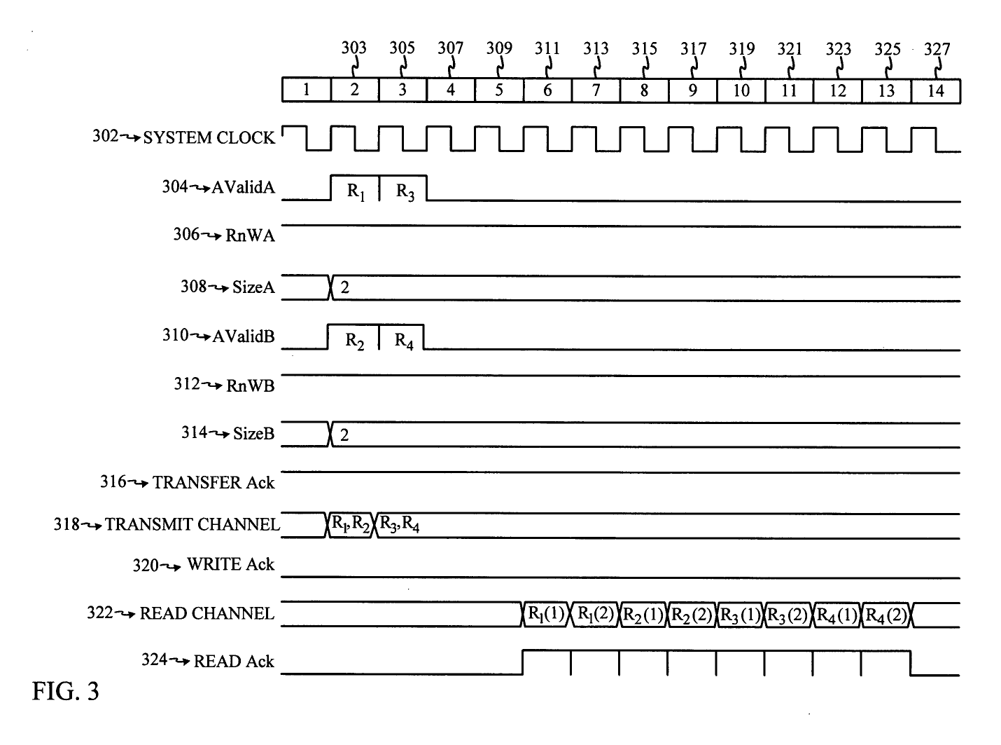

FIG. 3 is a timing diagram showing four address pipelined read operations over a multiple address two channel bus. A System Clock 302 may be used to synchronize communications between the sending component and the receiving component. The System Clock 302 is shown with fourteen clock cycles, with each cycle numbered sequentially for ease of explanation.

Two read operations may be initiated by the sending component during the second clock cycle 303. This may be achieved by broadcasting an address location associated with a first read operation R₁ as Address A and an address location associated with a second read operation R₂ as Address B over the Transmit Channel 318. The read operation may be selected by asserting read/write signal indicators for Addresses A and B to “1”. The read/write signal indicators for Addresses A and B are shown in FIG. 3 as R/W A 306 and R/W B 312, respectively. The sending component may also alert the receiving component that address locations will be broadcast by asserting A ValidA 304 and A ValidB 310 signals. Finally, the sending component may provide the receiving component with signals indicating the size of the payload for the read operations. These signals are shown in FIG. 3 as SizeA 308 for Address A and SizeB 314 for Address B. The number of clock cycles needed to broadcast the payload, commonly referred to in the art as data beats, may be used to indicate the size of the payload. By way of example, SizeA 308 and SizeB 314 both indicate two data beats. This means that one 16-byte payload is to be read from a block of 16 sequential address locations starting at Address A and another 16-byte payload is to be read from a block of 16 sequential address locations starting at Address B.

The receiving component may monitor the A ValidA 304 and A ValidB 310 signals to determine when valid address locations are broadcast on the Transmit Channel 318. When the receiving component detects the assertion of the A ValidA 304 and A ValidB 310 signals, it may sample the address information from the Transmit Channel 318 and sample the read/write signal indicators R/W A 306 and R/W B 312 to determine whether the sending component is requesting a read or write operation for Addresses A and B. Based on this information, and the size of the payload indicated by the SizeA 308 and SizeB 314 signals, the receiving component may begin retrieving read data at the appropriate address locations. The receiving component may also assert a Transfer Ack 316 signal indicating that it has successfully received the broadcast.

At the end of the second clock cycle 303, the sending component may detect the assertion of the Transfer Ack 316 signal, and respond by initiating two more read operations. This may be achieved by broadcasting an address location associated with a third read operation R₃ as Address A and an address location associated with a fourth read operation R₄ as Address B over the Transmit Channel 318, setting the read/write signal indicators R/W A 306 and R/W B 312 to “1,” asserting the A ValidA 304 and A ValidB 310 signals, and indicating to the receiving component the size of the payload using the SizeA 308 and SizeB 314 signals. In this case, the size of the payload for both read operations is 16-bytes.

The receiving component may detect the assertion of the A ValidA 304 and A ValidB 310 signals, sample the address information from the Transmit Channel 318, and sample the read/write signal indicators R/W A 306 and R/W B 312. Based on this information, and the size of the payload indicated by the SizeA 308 and SizeB 314 signals, the receiving component may begin retrieving read data at the appropriate address locations. The receiving component may also assert the Transfer Ack 316 signal indicating that it has successfully received the broadcast.

Once the sending component detects the assertion of the Transfer Ack 316 signal at the end of the third clock cycle 305, it may deassert the A ValidA 304 and A ValidB 310 signals, indicating to the receiving component that a read or write operation will not be requested during the fourth clock cycle 307.

Due to the read latency of the receiving component, a several clock cycle delay may be experienced before the read data is available. In this case, the first 8-bytes of the read data R₁(1) associated with the first read operation R₁ may be retrieved from the receiving component and broadcast on the Read Channel 322 during the sixth clock cycle 311, and the second 8-bytes of read data R₁(2) associated with the first read operation R₁ may be retrieved from the receiving component and broadcast on the Read Channel 322 during the seventh clock cycle 313.

In a similar fashion, the read data R₂(1) and R₂(2) associated with the second read operation R₂ may be retrieved from the receiving component and broadcast on the Read Channel 322 during the eighth and ninth clock cycles 315 and 317, the read data R₃(1) and R₃(2) associated with the third read operation R₃ may be retrieved from the receiving component and broadcast on the Read Channel 322 during the tenth and eleventh clock cycles 319 and 321, and the read data R₄(1) and R₄(2) associated with the fourth read operation R₄ may be retrieved from the receiving component and broadcast on the Read Channel 322 during the twelfth and thirteenth clock cycles 323 and 325.

During this eight clock cycle broadcast, the receiving component may assert a Read Ack 324 signal to indicate to the sending component that it is broadcasting read data on the Read Channel 322.

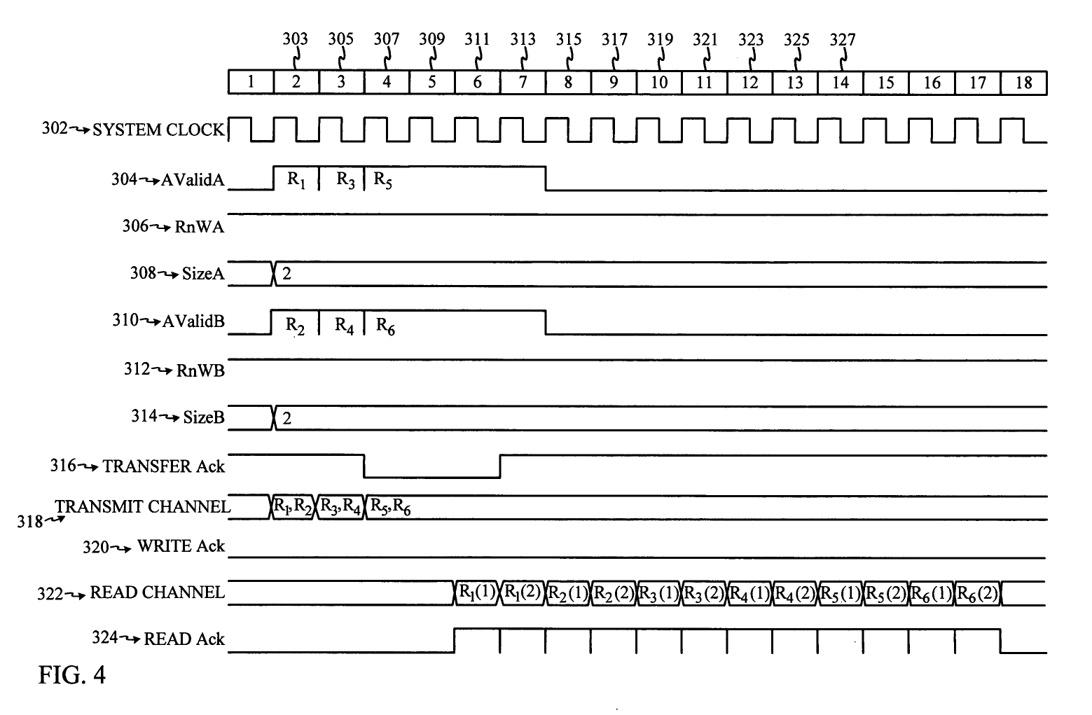

FIG. 4 is a timing diagram showing six address pipelined read operations over a multiple address two channel bus. The four read operations described earlier in connection with FIG. 3 are repeated in FIG. 4, and therefore, do not warrant further discussion here.

Two additional read operations may be initiated by the sending component in the fourth clock cycle 307 by broadcasting an address location associated with a fifth read operation R₅ as Address A and an address location associated with a sixth read operation R₆ as Address B over the Transmit Channel 318, setting read/write signal indicators R/W A 306 and R/W B 312 to “1,” asserting the A ValidA 304 and A ValidB 310 signals, and indicating to the receiving component the size of the payload using the SizeA 308 and SizeB 314 signals.

During the same clock cycle, the receiving component may deassert the Transfer Ack 316 signal indicating that it cannot currently accept the broadcast because, by way of example, it's address queue is full. The sending component may detect that the Transfer Ack 316 signal is not asserted at the end of the fourth clock cycle 307. In response, the sending component may continue to broadcast the address locations for the fifth and sixth read operations R₅ and R₆ on the Transmit Channel 318, along with the appropriate settings for the read/write signal indicators R/W A 306 and R/W B 312, the A ValidA 304 and A ValidB 310 signals, and the SizeA 308 and SizeB 314 signals, until the sending component detects the assertion of the Transfer Ack 316 signal from the receiving component. In this case, the broadcast is repeated in the fifth, sixth and seventh clock cycles 309, 311 and 313. During the seventh cycle 313, the receiving component may be able to receive a broadcast on the Transmit Channel 318 and perform the requested operation, as indicated by the assertion of the Transfer Ack 316 signal. In response to the assertion of the Transfer Ack 316 signal, the sending component determines that it does not need to send a repeat broadcast during the eighth clock cycle 315, and deasserts the A ValidA 304 and A ValidB 310 signals.

Alternatively, the sending component may queue the broadcast for the address locations associated with the fifth and sixth read operations when it detects that the Transfer Ack 316 signal is not asserted at the end of the fourth clock cycle 307. The broadcast may be queued until the receiving component indicates that it is ready to accept a broadcast over the Transmit Channel 318 by reasserting the Transfer Ack 316 signal. In this case, the sending component may monitor the Transfer Ack 316 signal until it is asserted by the receiving component in the seventh clock cycle 313. When the sending component detects that the Transfer Ack 316 is asserted, it may rebroadcast the queued address locations over the Transmit Channel 318 in the eighth clock cycle 315, along with the appropriate settings for the read/write signal indicators R/W A 306 and R/W B 312, the A ValidA 304 and A ValidB 310 signals, and the SizeA 308 and SizeB 314 signals. During the fifth, sixth and seventh clock cycles 309, 311, and 313, the sending component may broadcast new address locations on the Transmit Channel 318, or broadcast any outstanding write data to the receiving component.

Returning to FIG. 4, the receiving component may be able to receive a broadcast on the Transmit Channel 318 and perform the requested operation in the seventh clock cycle 313. More specifically, the receiving component may sample the address information from the Transmit Channel 318, and sample the read/write signal indicators R/W A 306 and R/W B 312. Based on this information, and the size of the payload indicated by the SizeA 308 and SizeB 314 signals, the receiving component may begin retrieving the read data at the new address locations. The first 8-bytes of the read data R₅(1) associated with the fifth read operation R₅ may be retrieved from the receiving component and broadcast on the Read Channel 322 during the fourteenth clock cycle 327, and the second 8-bytes of read data R₅(2) associated with the fifth read operation R₅ may be retrieved from the receiving component and broadcast on the Read Channel 322 during the fifteenth clock cycle 329. Similarly, the first 8-bytes of the read data R₆(1) associated with the sixth read operation R₆ may be retrieved from the receiving component and broadcast on the Read Channel 322 during the sixteenth clock cycle 331, and the second 8-bytes of read data R₆(2) associated with the sixth read operation R₆ may be retrieved from the receiving component and broadcast on the Read Channel 322 during the seventeenth clock cycle 333

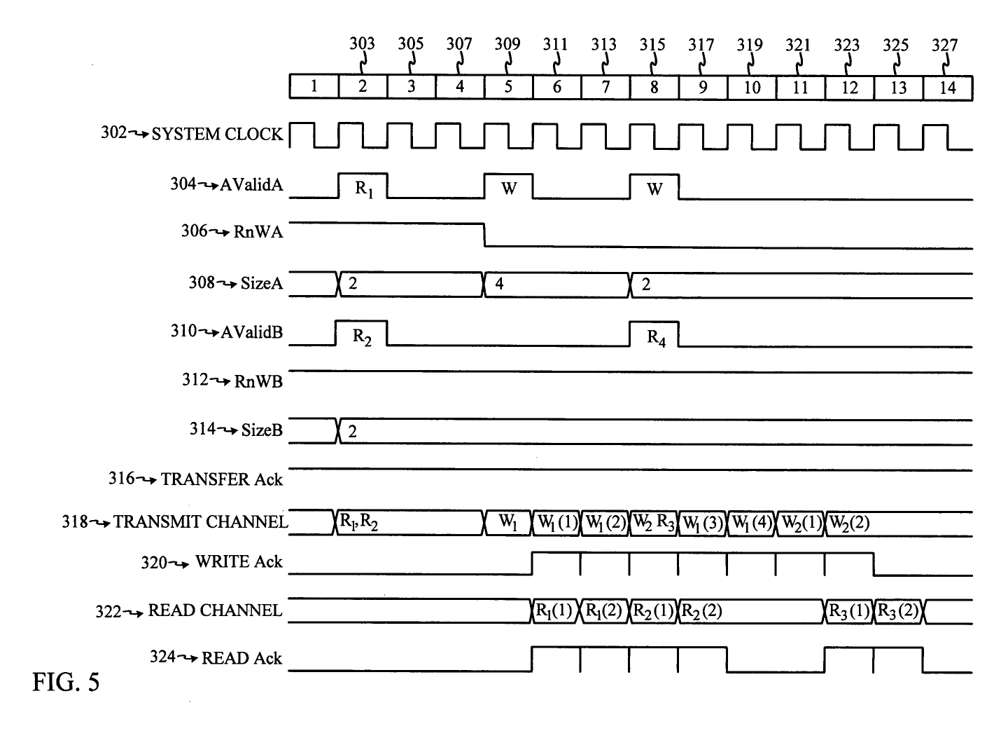

FIG. 5 is a timing diagram showing read and write operations over a multiple address two channel bus. Two read operations may be initiated by the sending component during the second clock cycle 303. This may be achieved by broadcasting an address location associated with a first read operation R₁ as Address A and an address location associated with a second read operation R₂ as Address B over the Transmit Channel 318, setting read/write signal indicators R/W A 306 and R/W B 312 to “1,” asserting the A ValidA 304 and A ValidB 310 signals, and indicating to the receiving component the size of the payload using the SizeA 308 and SizeB 314 signals. In this case, the size of the payload for the read operation at both address locations is 16-bytes.

The receiving component may detect the assertion of the A ValidA 304 and A ValidB 310 signals, sample the address information from the Transmit Channel 318, and sample the read/write signal indicators R/W A 306 and R/W B 312. Based on this information, and the size of the payload indicated by the SizeA 308 and SizeB 314 signals, the receiving component may begin retrieving read data at the appropriate address locations. The receiving component may also assert the Transfer Ack 316 signal indicating that it has successfully received the broadcast.

The sending component may detect the assertion of the Transfer Ack 316 signal at the end of the second clock cycle 303. Responsive to the assertion of the Transfer Ack 316 signal, the sending component may deassert the A ValidA 304 and A ValidB signals 310. By deasserting the A ValidA 304 and the A ValidB 310 signals, the sending component is indicating to the receiving component that it will either broadcast write data on the Transmit Channel 318, or nothing at all on the Transmit Channel 318. In this case, nothing will be broadcast on the Transmit Channel 318 because a write operation request has not been made.

In the fifth clock cycle 503, the sending component may initiate a write operation by broadcasting an address location associated with a first write operation W₁ as Address A over the Transmit Channel 318, setting the read/write signal indicator R/W A 306 to “0” to indicate a write operation, asserting the A ValidA 304 signal to alert the receiving component of an address location broadcast, and indicating to the receiving component the size of the payload using the SizeA 308 signal. In this case, the size of the payload for the write operation is 32-bytes as indicated in FIG. 5 by four data beats.

In response to this broadcast, the receiving component may assert the Transfer Ack 316 signal during the fifth clock cycle 309 indicating that it has successfully received the broadcast. The receiving component may also assert the Write Ack 320 signal during the sixth clock cycle 311 indicating that it is ready to write data to the address location associated with the first write operation W₁.

In the sixth clock cycle 311, the sending component may deassert the A ValidA signal 304. As explained earlier, by deasserting the A ValidA 304 signal, the sending component is indicating to the receiving component that it will either broadcast write data on the Transmit Channel 318, or nothing at all on the Transmit Channel 318. In this case, the receiving component will be looking for the first 8-bytes of the write data associated with the first write operation W₁. Although a second write operation may be requested at any time by asserting the A ValidA and/or A ValidB signals 304 and 310, the sending component will not send write data for the second write operation until the broadcast of the write data for the first write operation is complete. This approach tends to reduce sideband signaling requirements that might otherwise be required to indicate which write operation the payload is associated with.

With the A ValidA signal 304 deasserted, the sending component may broadcast on the Transmit Channel 318 the first 8-bytes of the write data W₁(1) associated with the first write operation W₁. The receiving component may write the data to the appropriate block of 8 address locations.

Concurrently, the first 8-bytes of the read data R₁(1) associated with the first read operation R₁ may be retrieved from the receiving component and broadcast on the Read Channel 322. The receiving component may also assert the Read Ack 324 signal indicating that it is sending read data on the Read Channel 322.

With the Write Ack 320 signal still asserted in the seventh clock cycle 313, the sending component may broadcast on the Transmit Channel 318 the second 8-bytes of the write data W₁(2) associated with the first write operation W₁. The receiving component may write the data to the appropriate block of 8 address locations.

Concurrently, the second 8-bytes of the read data R₁(2) associated with the first read operation R₁ may be retrieved from the receiving component and broadcast on the Read Channel 322. The receiving component may also assert the Read Ack 324 signal.

In the eighth clock cycle 315, the sending component may temporarily suspend broadcasting write data to initiate a new write operation followed by a new read operation. This may be achieved by broadcasting an address location W₂ associated with a second write operation as Address A and an address location associated with a third read operation R₃ as Address B over the Transmit Channel 318, setting the read/write indicator signal R/W A 306 to “0,” setting the read/write indicator signal R/W B 312 to “1,” asserting the A ValidA 304 and A ValidB 310 signals, and indicating to the receiving component the size of the payload using the SizeA 308 and SizeB 314 signals. In this case, the payload size for both the write and read operations is 16-bytes.

During the same eighth clock cycle 315, the first 8-bytes of the read data R₂(1) associated with the second read operation R₂ may be retrieved by the receiving component and broadcast on the Read Channel 322. The receiving component may also assert the Read Ack 324 signal.

In the ninth clock cycle 317, the sending component may deassert the A ValidA 304 and the A ValidB 310 signals indicating to the receiving component that the sending component will resume broadcasting write data on the Transmit Channel 318. With the Write Ack 320 signal still asserted, the sending component may broadcast on the Transmit Channel 318 the third 8-bytes of the write data W₁(3) associated with the first write operation W₁. The receiving component may write the data to the appropriate block of 8 address locations.

Concurrently, the second 8-bytes of the read data R₂(2) associated with the second read operation R₂ may be retrieved from the receiving component and the broadcast on the Read Channel 322. With this broadcast, the receiving component has completed both read operations initiated by the sending component during the second clock cycle 303, and therefore, may deassert the Read Ack 324 signal. Due to the read latency of the receiving component, it may not ready to broadcast the read data associated with the third read operation R₃.

With the Write Ack 320 signal still asserted through the twelfth clock cycle 323, the sending component may broadcast on the Transmit Channel 318 the final 8-bytes of the write data W₁(4) associated with the first write operation W₁ in the tenth clock cycle 319. The sending component may also broadcast the first 8-bytes of the write data W₂(1) associated with the second write operation W₂ in the eleventh clock cycle 321 and the last 8-bytes of the write data W₂(2) associated with the second write operation W₂ in the twelfth clock cycle 323. The receiving component may write this data to the appropriate block of 16 address locations. With this broadcast, the outstanding write operations are complete, and therefore, the receiving component may deassert the Write Ack 320 signal in the following clock cycle 325.

In the twelfth clock cycle 323, the first 8-bytes of the read data R₃(1) associated with the third read operation R₃ may be retrieved from the receiving component and broadcast on the Read Channel 322. In the following clock cycle 325, the second 8-bytes of read data R₃(2) associated with the third read operation R₃ may be retrieved from the receiving component and broadcast on the Read Channel 322. At the completion of the final broadcast of read data, the receiving component may deassert the Read Ack 324 signal in the fourteenth clock cycle 327.

The ability of the processing system to broadcast address information in the middle of a write operation that extends over multiple clock cycles may depend on the buffering capabilities of the sending and receiving components. In at least one embodiment of the processing system, the sending component may be implemented with a programmable means for enabling or disabling this feature based on potential performance advantages or supported buffering capabilities.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in the sending and/or receiving component, or elsewhere. In the alternative, the processor and the storage medium may reside as discrete components in the sending and/or receiving component, or elsewhere.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of communicating between a sending component and a receiving component over a bus, the bus comprising first and second channels, the method comprising:
broadcasting from the sending component on the first channel read address information comprising a plurality of read address locations, write address information comprising a plurality of write address locations, and write data, and wherein the sending component broadcasts the read and write address information multiple address locations at a time;
storing the write data broadcast on the first channel at the receiving component based on the write address information;
retrieving read data from the receiving component based on the read address information; and
broadcasting from the receiving component the retrieved read data on the second channel.

2. The method of claim 1 further comprising signaling from the sending component to the receiving component to indicate the sequence in which the receiving component will store the write data, retrieve the read data, or store the write data and retrieve the read data for each of the multiple address location broadcasts.

3. The method of claim 1 wherein the sequence in which the receiving component stores the write data, retrieves the read data, or stores the write data and retrieves the read data for each of the multiple address location broadcasts is based on the manner in which the multiple address locations are broadcast.

4. The method of claim 1 wherein the first channel comprises a plurality of lines with each of the address locations for each of the multiple address location broadcasts occupying a portion of the lines, and wherein the sequence in which the receiving component stores the write data, retrieves the read data, or stores the write data and retrieves the read data for each of the multiple address location broadcasts is based on the manner in which the multiple address locations are apportioned among the lines.

5. The method of claim 1 wherein each of the multiple address location broadcasts comprises two of the read address locations, two of the write address locations, or one of the read address locations and one of the write address locations.

6. The method of claim 1 wherein the first channel comprises a plurality of lines with a first portion of the lines allocated for one of the multiple address locations and a second portion of the lines allocated for the other multiple address location for each of the multiple address location broadcasts, and wherein the receiving component performs the operation associated with the address location allocated to the first portion of the lines before performing the operation associated with the address location allocated to the second portion of lines.

7. The method of claim 1 wherein at least a portion of the write data is broadcast on the first channel concurrently with the broadcast of at a least a portion of the retrieved read data on the second channel.

8. The method of claim 1 wherein at least a portion of the read or write address information is broadcast on the first channel concurrently with the broadcast of at least a portion of the retrieved read data on the second channel.

9. The method of claim 1 wherein the sending component broadcasts the read address information, the write address information and the write data on the first channel in a time division multiplexed fashion.

10. The method of claim 9 wherein the write data comprises a plurality of payloads, and wherein the receiving component stores each of the payloads based on one of the write address locations.

11. The method of claim 10 wherein the sending component performs one of the multiple address location broadcasts between first and second portions of one of the payloads.

12. The method of claim 11 wherein the multiple address broadcast between the first and second portions of said one of the payloads comprises two of the read address locations, two of the write address locations, or one of the read address locations and one of the write address locations.

13. The method of claim 1 further comprising signaling from the receiving component to the sending component to acknowledge each of the address locations for each of the multiple address location broadcasts.

14. The method of claim 13 further comprising repeat broadcasting one of the address locations for one of the multiple address location broadcasts in response to the receiving component failing to acknowledge said one of the address locations.

15. The method of claim 1 further comprising signaling from the sending component to the receiving component to indicate when each of the multiple address location broadcasts is occurring on the first channel.

16. A processing system, comprising:
a bus having first and second channels; and
a sending component configured to broadcast on the first channel read address information comprising a plurality of read address locations, write address information comprising a plurality of write address locations, and write data, the sending component being further configured to broadcast the read and write address information multiple address locations at a time; and
a receiving component configured to store the write data broadcast on the first channel based on the write address information, retrieve read data based on the read address information, and broadcast the retrieved read data on the second channel to the sending component.

17. The processing system of claim 16 wherein the receiving component is further configured to store the write data, retrieve the read data, or store the write data and retrieve the read data for each of the multiple address location broadcasts in a sequence based on signaling from the sending component.

18. The processing system of claim 16 wherein the receiving component is further configured to store the write data, retrieve the read data, or store the write data and retrieve the read data for each of the multiple address location broadcasts in a sequence based on the manner in which the multiple address locations are broadcast.

19. The processing system of claim 16 wherein the first channel comprises a plurality of lines with each of the address locations for each of the multiple address location broadcasts occupying a portion of the lines, and wherein the receiving component is further configured to store the write data, retrieve the read data, or store the write data and retrieve the read data for each of the multiple address location broadcasts in a sequence based on the manner in which the multiple address locations are apportioned among the lines.

20. The processing system of claim 16 wherein each of the multiple address location broadcasts comprises two of the read address locations, two of the write address locations, or one of the read address locations and one of the write address locations.

21. The processing system of claim 20 wherein the first channel comprises a plurality of lines with a first portion of the lines allocated to one of the multiple address locations and a second portion of the lines allocated to the other multiple address location for each of the multiple address location broadcasts, and wherein the receiving component is further configured to perform the operation associated with the address location allocated to the first portion of the lines before performing the operation associated with the address location allocated to the second portion of lines.

22. The processing system of claim 16 wherein the sending component is further configured to broadcast at least a portion of the write data on the first channel at the same time the receiving component broadcasts at least a portion of the retrieved read data on the second channel.

23. The processing system of claim 16 wherein the sending component is further configured to broadcast at least a portion of the read or write address information on the first channel at the same time the receiving component broadcasts at least a portion of the retrieved read data on the second channel.

24. The processing system of claim 16 wherein the sending component is further configured to broadcast the read address information, the write address information and the write data on the first channel in a time division multiplexed fashion.

25. The processing system of claim 24 wherein the write data comprises a plurality of payloads, and wherein the receiving component is further configured to store each of the payloads based on one of the write address locations.

26. The processing system of claim 25 wherein the sending component is further configured to perform one of the multiple address location broadcasts between first and second portions of one of the payloads.

27. The processing system of claim 26 wherein the sending component is further configured to perform said one of the multiple address location broadcasts between the first and second portions of said one of the payloads by concurrently broadcasting two of the read address locations, two of the write address locations, or one of the read address locations and one of the write address locations.

28. The processing system of claim 16 wherein the receiving component is further configured to signal the receiving component to acknowledge each of the address location for each of the multiple address location broadcasts.

29. The processing system of claim 28 wherein the sending component is configured further comprising repeat broadcasting one of the address locations for one of the multiple address location broadcasts if the receiving component does not acknowledge said one of the address locations.

30. The processing system of claim 16 wherein the sending component is further configured to signal the receiving component to indicate when each of the multiple address location broadcasts is occurring on the first channel.

31. A processing system, comprising:
a bus having first and second channels;
means for broadcasting on the first channel read address information comprising a plurality of read address locations, write address information comprising a plurality of write address locations, and write data, the read and write address information being broadcast multiple address locations at a time; and
means for storing the write data broadcast on the first channel based on the write address information, retrieving read data based on the read address information, and broadcasting the retrieved read data on the second channel.
